(19) United States
(12) Patent Application Publication
(10) Pub. No.: US 2014/0078300 A1
(43) Pub. Date: Mar. 20, 2014

(54) ADJUSTING SURVEILLANCE CAMERA PTZ TOURS BASED ON HISTORICAL INCIDENT DATA

(71) Applicants: STEVEN D. TINE, BUFFALO GROVE, IL (US); TYRONE D. BEKIARES, PARK RIDGE, IL (US); RODNEY D. GUY, HAWTHORN WOODS, IL (US)

(72) Inventors: STEVEN D. TINE, BUFFALO GROVE, IL (US); TYRONE D. BEKIARES, PARK RIDGE, IL (US); RODNEY D. GUY, HAWTHORN WOODS, IL (US)

(73) Assignee: MOTOROLA SOLUTIONS, INC., Schaumburg, IL (US)

(21) Appl. No.: 13/618,695

(22) Filed: Sep. 14, 2012

(51) Int. Cl. H04N 5/232

(52) U.S. Cl. 348/143; 348/E05.042

(57) ABSTRACT

A method and apparatus to provide a PTZ tour to a camera is provided herein. During operation, a processor extracts historical incident data and generates an incident heat map of an area based on the historical incident data. A camera viewshed is determined and utilized along with the incident heat map to generate a PTZ tour for a camera.

### FIELD OF THE INVENTION

The present invention generally relates to surveillance camera adjustments, and more particularly to a method and apparatus for automatically adjusting a surveillance camera's field of view based on historical incident data.

### BACKGROUND OF THE INVENTION

The use of surveillance video continues to grow across enterprise and public safety markets. One common challenge associated with surveillance cameras is selecting an appropriate field of view. Stationary cameras with a fixed field of view are limited to surveillance of a given area. Conversely, cameras with mechanical or digital pan, tilt, and zoom controls can modify their field of view remotely to select any field of view within the camera's overall viewshed, or potential fields of view. The current field of view of the camera can be manually selected or manipulated by a user that is actively viewing the camera.

Conveniently, the field of view can also be automatically selected as part of an automated pan, tilt, zoom (PTZ) tour, such that the field of view of the camera is changed over time according to some preconfigured schedule. In some instances, the PTZ tour may modify the field of view continuously along one or more axes. In other instances, the camera may be scheduled to rotate periodically between two or more fixed fields of view. Thus, an automated PTZ tour enables the camera to effectively capture a much wider field of view with respect to a stationary camera. For example, a camera mounted on the roof of a building can be scheduled to periodically rotate its field of view between two entrances of a building, thus permitting one camera to affect surveillance over both entrances.

A common problem associated with public safety surveillance cameras configured for automated PTZ tour operation is the potential to miss capture of an incident within the viewshed of the camera, but not within the camera's current field of view. Obviously, the value of the camera is largely dependent on its ability to capture incidents in progress. Thus, increasing the probability that a camera captures an incident is of utmost importance. Therefore, there exists a need for a method and apparatus for automatically adjusting a surveillance camera's field of view, such that the likelihood of an incident occurring within that field of view is increased.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram detailing a tour scheduler.

FIG. 2 is block diagram detailing a camera controller.

FIG. 3 is a block diagram detailing a camera.

FIG. 4 is a flow chart showing the operation of the tour scheduler of FIG. 1.

FIG. 5 is a flow chart the operation of the camera controller of FIG. 2.

FIG. 6 is a flow chart showing operation of a camera of FIG. 3.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the aforementioned need, a method and apparatus for determining an optimized PTZ tour schedule for a camera is provided herein. During operation, a processor analyzes historical incident data and generates an incident heat map of a given area. A viewshed is determined for a particular camera and utilized along with the incident heat map to generate a PTZ tour schedule for that camera. In one embodiment of the present invention, the camera viewshed is determined by geo-locating the camera and using a topographical map, inclusive of natural and manmade features, to determine unobstructed potential fields of view.

Describing the above in further detail, an algorithm processes historical incident data to create a heat map of incident hot spots. Incidents may comprise any event that is desired to be captured by the camera. For example, incident hot spots may comprise crime hot spots, or traffic accident hot spots, weather phenomenon, etc. The creation of a heat map may be accomplished via a standard software package such as The Omega Group's CrimeView® desktop crime analysis and mapping solution. This incident data heat map is used to identify the parts of a city, building, or other area that have a high probability of future incidents (with the assumption that past incident data is an indicator of likely future incidents of a similar type).

The incident heat map may vary depending on time of day, time of year, and environmental factors such as weather conditions and the like. Armed with the knowledge of where, when, and under what conditions future incidents are likely to occur, the locations of increased incident activity within the heat map are correlated with the viewshed of given camera. A PTZ tour schedule is then constructed over some time period (i.e., a day), such that for a given time, date, and environmental conditions, areas with increased incident activity are more frequently observed by the camera. The above process can be repeated after a predetermined period of time, for example, on a daily, weekly, or monthly schedule.

Operating cameras as described above will automatically adjust their field of view to provide an improved chance of capturing future incidents on a video recording. For example, Bar A (in the Eastern portion of a camera's viewshed) closes at 2 AM each night and historical incident data indicate a significant increase in the rate of assault and battery cases in the vicinity between 2 to 3 AM on Fridays and Saturdays. Bar B (in the Western portion of the camera's viewshed) closes at 3 AM each night and historical incident data indicate a similar increase in crime in the vicinity between 3 to 4 AM on Fridays and Saturdays. Using this information, an optimal PTZ tour schedule may be determined for the camera. In this example, the camera's PTZ tour schedule may cause the camera's field of view to fixate on the entrance of Bar A from 2 to 3 AM and on the entrance to Bar B from 3 to 4 AM on Fridays and Saturdays. By comparison, a non-optimal PTZ tour schedule might simply rotate the camera's field of view periodically on one minute intervals between the entrance to Bar A and the entrance to Bar B.

If the historical incident data shows additional correlation beyond date, time, or season to more complex environmental factors such as weather patterns, moon phase, etc., a more dynamic PTZ tour schedule can be constructed accordingly. For example, historical incident data may indicate a higher incidence of traffic accidents at a particular intersection on rainy nights. As such, if a weather forecast calls for rain during the nighttime hours, the camera's PTZ tour schedule could be automatically updated to fixate the field of view on the intersection in question. This update may happen in advance based on a weather forecast, or it may happen automatically upon detection of rainfall.

Prior to describing the system shown for accomplishing the above, the following definitions are provided to set the necessary background for utilization of the present invention.

Incident Heat Map: a map generated by analyzing historical Incident Data indicating the relative density of incidents across a geographical area. Areas with a higher density of incidents are typically referred to as ‘hot’ (and often visually displayed with shades of red) and areas with low incident density are referred to as ‘cold’ (and often visually displayed with shades of blue). Prior to rendering the Incident Heat Map, the Incident Data may be filtered based on any number of attributes. For example, one could build an Incident Heat Map depicting only violent crime over the past month.

Topographical Map—a map inclusive of natural and manmade topographical features such as streets, buildings, hills, bodies of water, and the like of an area of the Earth, showing them in their respective forms, sizes, and relationships according to some convention of representation.

Incident Data—A record of incidents. Typically, at a minimum, the location, type, severity, and date/time attributes of the incident are recorded. Additional environmental factors may also be recorded (e.g., the weather at the time of the incident, etc). Examples of incident data include, for example, crime data, traffic accident data, weather phenomena, and/or individual schedules (e.g., a mayor's schedule).

PTZ Tour—an operational mode whereby the camera is configured to automatically change its field of view over time. In one embodiment, the selected field of view within the camera's overall viewshed is obtained via automated manipulation of Pan, Tilt, and Zoom (PTZ) motors attached to the camera. In an alternate embodiment of the present invention, the selected field of view within the camera's overall viewshed is obtained via automated, digital manipulation of a captured fixed field of view. In such embodiments, the camera is typically configured with a high resolution, wide angle lens and a high definition sensor. The camera then applies post processing techniques to digitally pan, tilt, and zoom a dynamically selected, narrow field of view (also known as a region of interest) within the fixed, captured, wide angle field of view. In yet another embodiment of the present invention, part of the PTZ tour is the ability for the camera to move its geographic location (like a camera on a moveable track or mounted in an unmanned aerial vehicle) in order to see a new field of view. In all cases, a camera may continually move its field of view, or rotate through a predefined series of fields of view, remaining at each field of view for a predetermined amount of time.

Camera Viewshed—The spatial area that a given camera can potentially view. The viewshed may take into account the geographical location of the camera, mounting height, and PTZ capabilities of the camera while also accounting for physical obstructions of the field of view. These obstructions may be determined by a topographical map. The viewshed may also take into all the views possible for a camera that has the ability move its geographic location (like a camera on a moveable track or mounted in an unmanned aerial vehicle).

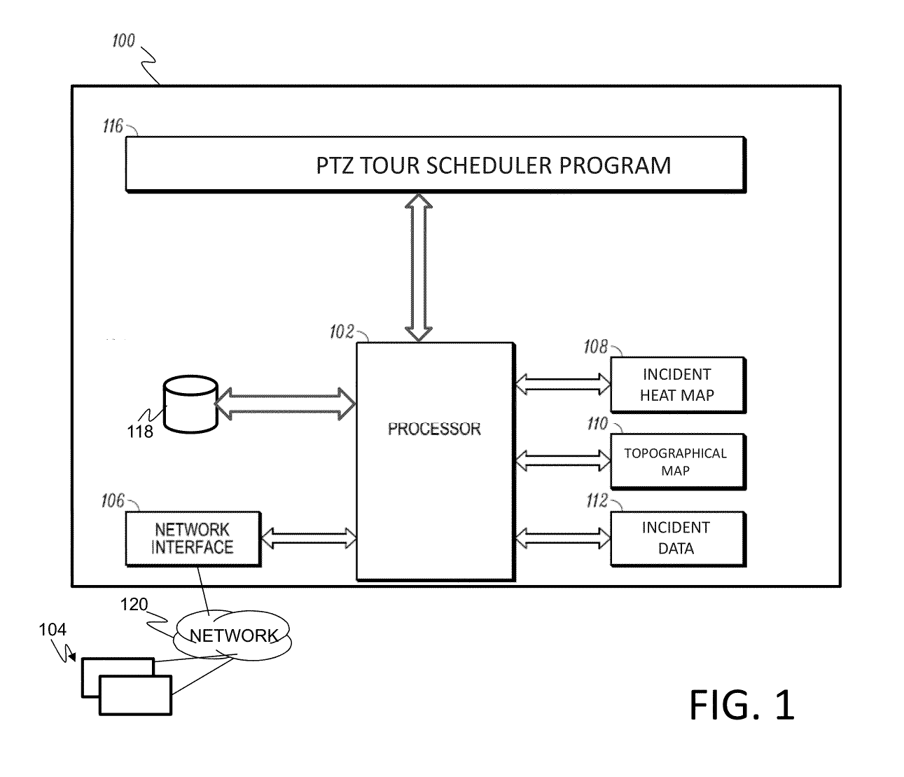

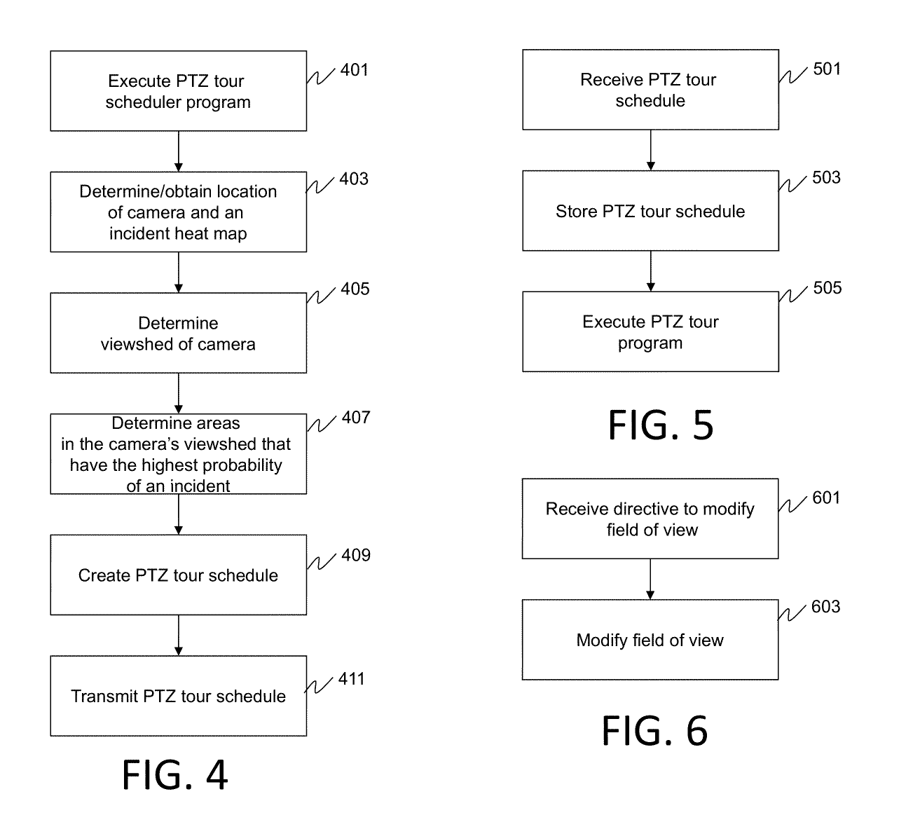

FIG. 1 is a block diagram illustrating a general operational environment detailing device tour scheduler device 100 according to one embodiment of the present invention. In general, as used herein, the tour scheduler device 100 being “configured” or “adapted” means that the device 100 is implemented using one or more components (such as memory components, network interfaces, and central processing units) that are operatively coupled, and which, when programmed, form the means for these system elements to implement their desired functionality, for example, as illustrated by reference to the methods shown in FIG. 4.

In the current implementation, tour scheduling device 100 is adapted to compute PTZ tour schedules for multiple cameras and provide the tour schedules to a camera controller. However it should be understood that various embodiments may exist where the camera controllers or cameras themselves compute their own PTZ tour schedules as described below.

Tour scheduling device 100 comprises a processor 102 that is communicatively coupled with various system components, including a network interface 106, a general storage component 118, a storage component storing an incident heat map 108, optionally a storage component storing a topographical map 110, and a storage component storing incident data 112. The tour scheduling device 100 further comprises a PTZ tour scheduler program 116 which may execute via an operating system (not shown). Only a limited number of system elements are shown for ease of illustration; but additional such elements may be included in the tour scheduling device 100. The functionality of the tour scheduling device may be embodied in various physical system elements, including a standalone device, or as functionality in a Network Video Recording device (NVR), a Physical Security Information Management (PSIM) device, a camera controller 104, a camera 204, or any other physical entity.

The processing device 102 may be partially implemented in hardware and, thereby, programmed with software or firmware logic (e.g., the PTZ tour scheduler program 116) for performing functionality described in FIG. 4; and/or the processing device 102 may be completely implemented in hardware, for example, as a state machine or ASIC (application specific integrated circuit). All storage and components can include short-term and/or long-term storage of various information needed for the functioning of the respective elements. The storage 118 may further store software or firmware (e.g., the PTZ tour scheduler program 116) for programming the processing device 102 with the logic or code needed to perform its functionality.

In the illustrative embodiment, one or more camera controllers 104 are attached (i.e., connected) to the tour scheduling device 100 through network 120 via network interface 106. Example networks 120 include any combination of wired and wireless networks, such as Ethernet, T1, Fiber, USB, IEEE 802.11, 3GPP LTE, and the like. Network interface 106 connects processing device 102 to the network 120. Where necessary, network interface 106 comprises the necessary processing, modulating, and transceiver elements that are operable in accordance with any one or more standard or proprietary wireless interfaces, wherein some of the functionality of the processing, modulating, and transceiver elements may be performed by means of the processing device 102 through programmed logic such as software applications or firmware stored on the storage component 118 or through hardware.

PTZ tour scheduler program (instructions) 116 may be stored in the storage component 118, and may execute via an operating system (not shown). When the PTZ tour scheduler program 116 is executed, it is loaded into the memory component (not shown) and executed therein by processor 102. Processing device 102 uses the PTZ tour scheduler program 116 to analyze current incident data and generate an incident heat map. Using a particular camera's geographic location or set of possible geographic locations and a topographical map 110, a camera viewshed is calculated. Alternatively, instead of being calculated, the camera viewshed may be obtained via other means (for example, a person may manually determine the camera viewshed via visual inspection of all the possible fields of view of the camera). The processing device 102 then compares the incident heat map against the camera's viewshed. A PTZ tour schedule is then constructed for a camera such that the field of view of the camera may be fixated for a greater period of time on an area with increased incident activity. The PTZ tour schedule is then transmitted to camera controller 104 through network 120.

In an alternate embodiment, the tour scheduling device 100 may be configured to generate the PTZ tour schedules for multiple cameras. In such a configuration, processing device 102 first selects a subset of cameras to subsequently configure PTZ tour schedules. This subset is determined by first computing a composite viewshed of multiple cameras. The processing device 102 then applies the composite viewshed as a mask to an incident heat map. Where the ‘hot’ spots of the incident heat map overlap with the composite viewshed, a camera is selected whose individual viewshed includes this overlap. A PTZ tour schedule is then constructed for the camera as described above. The processing device 102 may then remove the ‘hot spot’ from the heat map, such that coverage of this hot spot is not duplicated by other cameras. The process is then repeated for the remaining cameras with the ‘hot spot’ removed.

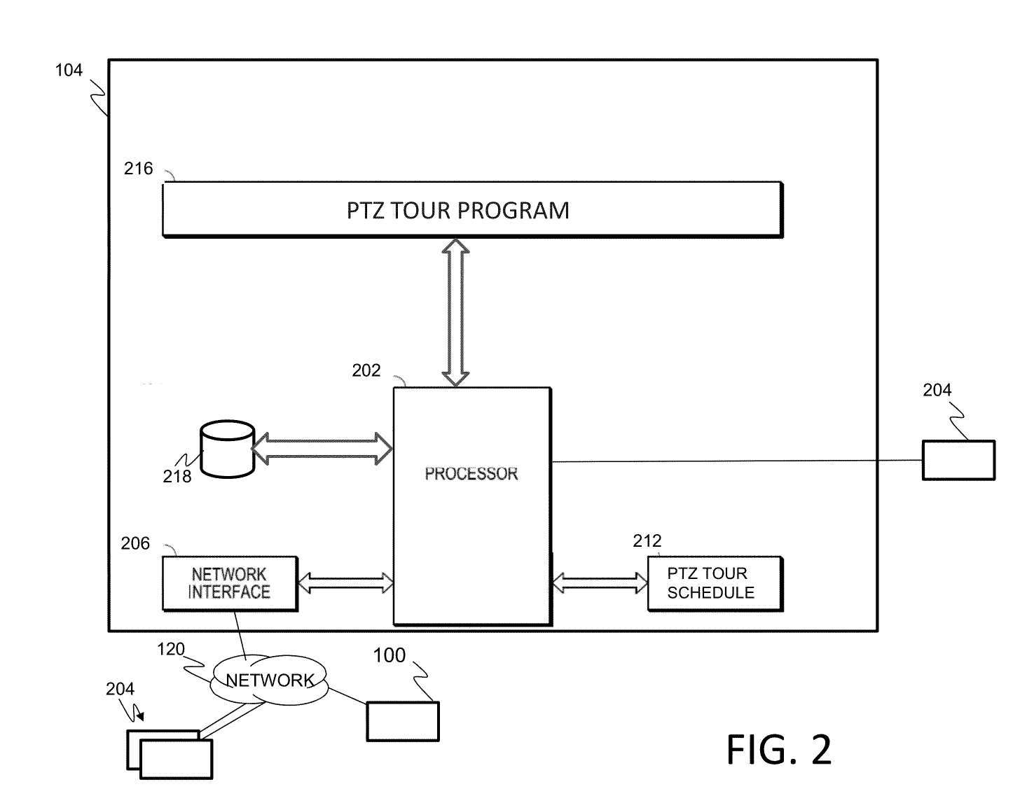

FIG. 2 is a block diagram illustrating a general operational environment detailing camera controller 104 according to one embodiment of the present invention. In general, as used herein, the camera controller 104 being “configured” or “adapted” means that the controller 104 is implemented using one or more components (such as memory components, network interfaces, and central processing units) that are operatively coupled, and which, when programmed, form the means for these system elements to implement their desired functionality, for example, as illustrated by reference to the methods shown in FIG. 5. Camera controller 104 comprises a processor 202 that is communicatively coupled with various system components, including a network interface 206, a general storage component 218, and a storage component storing a PTZ tour schedule 212. The camera controller 104 further comprises a PTZ tour program 216 which may execute via an operating system (not shown). Only a limited number of system elements are shown for ease of illustration; but additional such elements may be included in the camera controller 104.

The functionality of the camera controller device may be embodied in various physical system elements, including a standalone device, or as functionality in a Network Video Recording device (NVR), a Physical Security Information Management (PSIM) device, a PTZ tour scheduler 100, a camera 204, or any other physical entity. In other words, although shown as a stand-alone device, scheduler 100 may be included within a camera 204, or scheduler 100.

The processing device 202 may be partially implemented in hardware and, thereby, programmed with software or firmware logic or code (e.g., the PTZ tour program 216) for performing functionality described in FIG. 5; and/or the processing device 202 may be completely implemented in hardware, for example, as a state machine or ASIC (application specific integrated circuit). All storage and components can include short-term and/or long-term storage of various information needed for the functioning of the respective elements. Storage 218 may further store software or firmware (e.g., the PTZ tour program 216) for programming the processing device 202 with the logic or code needed to perform its functionality.

In the illustrative embodiment, one or more cameras 204 are either directly connected to controller 104, or attached (i.e., connected) to the camera controller controller 104 through network 120 via network interface 206. Network interface 206 connects processing device 202 to the network 120. Camera controller 104 is adapted to control a PTZ tour of any camera 204 that it is communication with. These include cameras connected to controller 104 through network 120, or cameras 204 directly coupled to controller 104.

PTZ tour schedules are periodically received from scheduler 100 and stored in storage 212. PTZ tour program 216 may be stored in the storage component 218, and may execute via an operating system (not shown). When the PTZ tour program 216 is executed, it is loaded into the memory component (not shown) and executed therein by the processor 202. Once executed, the PTZ tour program will load and execute, for each configured camera 204, a PTZ tour schedule 212 as determined and provided by PTZ tour scheduling device 100. As PTZ tour schedule 212 is executed, processor 202 will send appropriate commands to cameras 204 to adjust their fields of view accordingly.

For example, processor 202, per PTZ tour schedule 212, may instruct a camera 204 to change its field of view, based on the incident heat map, to cover a first location for a first period of time, then after the first period of time has passed, the processor 202 may instruct the camera 204 to change its field of view to cover a second location for a second period of time. The fields of view covered by any given camera are preferably adapted to view areas of increased incident activity at a greater frequency than other areas.

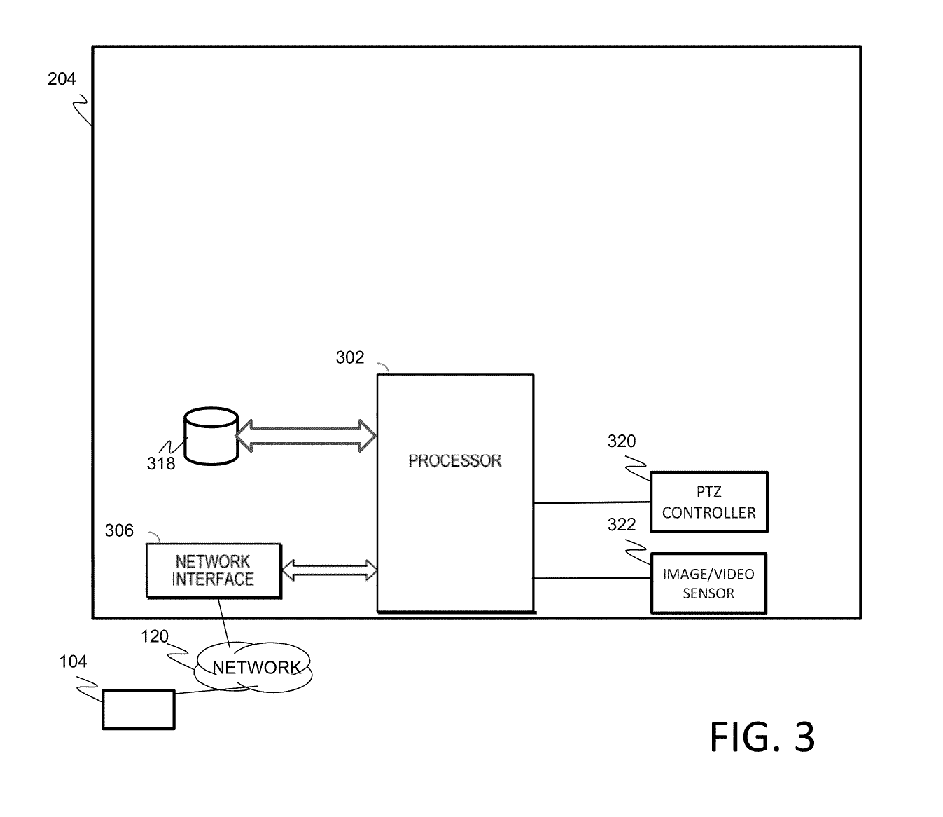

FIG. 3 is a block diagram illustrating a general operational environment detailing camera 204 according to one embodiment of the present invention. In general, as used herein, the camera 204 being “configured” or “adapted” means that the device 204 is implemented using one or more components (such as memory components, network interfaces, and central processing units) that are operatively coupled, and which, when programmed, form the means for these system elements to implement their desired functionality, for example, as illustrated by reference to the methods shown in FIG. 6. Camera 204 comprises a processor 302 that is communicatively coupled with various system components, including a network interface 306, a general storage component 318, a PTZ controller 320 to affect mechanical or digital field of view manipulation, and an image or video sensor 322 to capture images or video. Only a limited number of system elements are shown for ease of illustration; but additional such elements may be included in the camera 204. The functionality of the camera device may be embodied in various physical system elements, including a standalone device, or as functionality in a Network Video Recording device (NVR), a Physical Security Information Management (PSIM) device, a PTZ tour scheduler 100, a camera controller 104, or any other physical entity.

The processing device 302 may be partially implemented in hardware and, thereby, programmed with software or firmware logic or code for performing functionality described in FIG. 6; and/or the processing device 302 may be completely implemented in hardware, for example, as a state machine or ASIC (application specific integrated circuit). All storage and components can include short-term and/or long-term storage of various information needed for the functioning of the respective elements. Storage 318 may further store software or firmware for programming the processing device 302 with the logic or code needed to perform its functionality.

Sensor 322 (also interchangeably referred to herein as video camera or digital video camera) electronically captures a sequence of video frames (i.e., a sequence of one or more still images), with optional accompanying audio, in a digital format. Although not shown, the images or video captured by the image/video sensor 322 may be stored in the storage component 318, or in any storage component accessible via network 120.

In the illustrative embodiment, a camera 204 is attached (i.e., connected) to a camera controller controller 104 through network 120 via network interface 306, although in alternate embodiments, camera 204 may be directly coupled to controller 104. Network interface 306 connects processing device 302 to the network 120.

Processor 302 receives directives to modify its field of view from camera controller 104. Processor 302 then passes that directive to the PTZ controller 320. In some embodiments of cameras, the PTZ controller 320 utilizes mechanical motors to manipulate the camera's field of view. In other embodiments of cameras, the PTZ controller 320 utilizes digital processing to crop and/or zoom a captured field of view to generate the requested field of view.

For example, ten cameras 204 may be deployed at various locations around a neighborhood, and all ten cameras may be attached to one camera controller 104 through network 120. Tour scheduling device 100 sends PTZ tour schedules for the cameras 204 to the camera controller 104 via network 120. The camera controller 104 then executes the respective PTZ tour schedules, sending directives to modify the field of view to each camera 204 at the correct time to affect the requested PTZ tour schedule. These PTZ tour schedules are uniquely adapted to each camera's viewshed and are based on incident data within the camera's viewshed, such that areas with higher incident activity have a higher probability of being captured by the cameras 204. Camera 204 then modifies its field of view according to the field of view directives using PTZ controller 320.

FIG. 4 is a flow chart depicting the operation of the tour scheduler device of FIG. 1. The process flow of FIG. 4 describes the generation of a PTZ tour schedule by tour scheduler 100. As described above, it is not necessary that the PTZ tour schedule be generated by tour scheduler 100. In alternate embodiments of the present invention, this functionality may be located the camera controllers, cameras, or other system elements.

The logic flow begins at step 401 with the execution of PTZ tour scheduler program 116. When executed, processor 102 determines a geographic location or set of possible geographic locations (in the case of a moveable camera) for a particular camera 204 and determines and/or obtains an incident heat map for the particular area using historical incident data (step 403). In one embodiment, pre-manufactured software such as the Omega Group's CrimeView® is utilized by processor 102 to generate the heat map. The heat map may utilize incident data stored in storage 112 in the generation of the heat map. In an alternate embodiment of the present invention, the heat map may be created by a separate entity (not shown) and provided to the tour scheduler. Regardless of how the heat map is generated and/or obtained, the heat map is stored in storage 108.

At step 405, a topographical map stored in storage 110 may be utilized along with the camera's geographic location or set of possible geographic locations (which may also be stored in storage 110) to determine a camera viewshed for a particular camera. As discussed previously, the camera's viewshed comprises fields of view visible from the particular camera's geographic location or set of possible geographic locations (in the case of a moveable camera). The map may be used to determine obstructions such as buildings, bridges, hills, etc. that may obstruct the camera's view. In one embodiment, a location for a particular camera is determined and unobstructed views for the camera are determined based on the geographic location or set of possible geographic locations of the camera unobstructed views for the camera. The camera viewshed is then determined based on the unobstructed views for the camera at the location. In another embodiment, the camera's viewshed is determined by identifying the geographic location or set of possible geographic locations that the camera can occupy and simply determining that the camera can view a certain fixed distance around the geographic location or set of geographic locations based on the optics in the camera's lens. In yet another embodiment, the camera's viewshed is determined manually by having a person move the camera through all its possible views and noting on a map exactly which areas the camera can view. Regardless of how the viewshed is generated and/or obtained, the viewshed is stored in storage 118.

At step 407, processor 102 uses the heat map and the camera viewshed to determine the areas around the camera that have the highest probability of incident occurrence (i.e., a “hot spot”). The PTZ tour schedule is then created/generated based on this determination. More particularly, the PTZ tour schedule is created/generated based on the incident heat map and the camera viewshed such that a camera will fixate on those areas at times most likely to capture an incident with greater frequency (step 409). Thus, at step 409, the step of generating the schedule for the camera comprises the step of determining areas within the camera viewshed that have a higher probability of incident occurrence, and generating the schedule so that the camera (or multiple cameras) will fixate on those areas with greater frequency than other areas within its viewshed. More particularly, if a single camera is being operated according to a PTZ tour schedule, the single camera can be scheduled so that the camera captures areas of high incident occurrence with greater frequency. However, if multiple cameras are being provided with schedules, the schedules for each camera may be adjusted to work in unison with other cameras so that the multiple cameras working together capture areas of high incident occurrence with greater frequency.

Finally, at step 411 the PTZ tour schedule is communicated/transmitted to the particular camera 204 or camera controller 104 assigned to camera 204 using network interface 106. As discussed above, the tour schedule comprises a tour schedule for the camera to autonomously change its field of view. The tour schedule may comprise a PTZ tour schedule wherein the camera changes its field of view via pan-tilt-zoom (PTZ) motors, cropping or zooming.

It should be noted that while the logic flow of FIG. 4 describes the generation of a tour schedule for a single camera, the process flow of FIG. 4 may be repeatedly performed for multiple cameras such that each camera has a unique PTZ tour schedule to capture areas of higher incident occurrence with greater frequency.

FIG. 5 is a flow chart depicting the operation of the camera controller of FIG. 2. Although the camera controller may determine an appropriate PTZ tour schedule for a camera as described above, in this particular embodiment, the camera controller simply obtains the PTZ tour schedule from PTZ tour scheduler 100. The logic flow begins at step 501 where network interface 206 receives a PTZ tour schedule. At step 503, the PTZ tour schedule is stored in storage 212. Finally, processor 202 executes PTZ tour program 216 which reads the stored PTZ tour schedule, and sends appropriate directives to the appropriate camera at an appropriate time to adjust the camera's field of view accordingly.

FIG. 6 is a flow chart depicting the operation of the camera of FIG. 3. The logic flow begins at step 601 where network interface 306 receives a directive to change the camera's current field of view. At step 603, the Camera 204 then modifies its present field of view via PTZ controller 320. PTZ controller 320 may employ mechanical, digital, or other means to affect the camera's current field of view to comply with the directive.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for determining a Pan, Tilt, and/or Zoom (PTZ) schedule for a camera, the method comprising the steps of:
determining or obtaining a crime heat map, wherein the crime heat map indicates geographic areas with a probability of crime occurrence;
determining or obtaining a camera viewshed; and
generating the PTZ schedule for the camera based on the crime heat map and the camera viewshed.

2. The method of claim 1 wherein the step of determining the camera viewshed comprises the steps of:
determining or obtaining a geographic location or set of possible geographic locations for the camera;
using a map to determine unobstructed views for the camera based on the geographic location or set of possible geographic locations of the camera; and
determining the camera viewshed based on the unobstructed views for the camera.

3. The method of claim 1 wherein the step of generating the PTZ schedule for the camera comprises the step of determining areas within the camera viewshed that have a higher probability of crime occurrence, and generating the PTZ schedule so that the camera or multiple cameras captures those areas with greater frequency than other areas within the viewshed.

4. The method of claim 1 further comprising the step of:
transmitting the PTZ schedule to the camera or a camera controller.

5. (canceled)

6. The method of claim 1, wherein the PTZ tour schedule comprises a schedule for the camera to autonomously change its field of view.

7. The method of claim 6 wherein the camera changes its field of view via pan-tilt-zoom (PTZ) motors.

8. The method of claim 6 wherein the camera changes its field of view by using cropping or zooming to change the field of view.

9. A method for creating a camera Pan, Tilt, and/or Zoom (PTZ) schedule, the method comprising the steps of:
determining or obtaining a geographic location or set of possible geographic locations for a camera;
determining or obtaining a viewshed for the camera based on the geographic location or set of possible geographic locations;
creating a heat map for the geographic location or set of possible geographic locations using historical crime data, wherein the heat map comprises geographic areas with a probability of crime occurrence;
using the heat map and the viewshed to determine areas around the camera that have a greater probability of crime occurrence; and
using the heat map and the viewshed to create the camera Pan, Tilt, and/or Zoom (PTZ) schedule.

10. The method of claim 9 further comprising the step of:
transmitting the camera tour to the camera or a camera controller.

11. The method of claim 9 wherein the step of determining the viewshed for the camera comprises the steps of:
determining or obtaining a geographic location or set of possible geographic locations for the camera;
using a topographical map to determine unobstructed views for the camera based on the geographic location or set of possible geographic locations of the camera; and
determining the camera viewshed based on the unobstructed views for the camera.

12. (canceled)

13. The method of claim 9, wherein the PTZ tour schedule comprises a schedule for the camera to autonomously change its field of view.

14. The method of claim 13 wherein the camera changes its field of view by using pan-tilt-zoom (PTZ) motors to change the field of view.

15. The method of claim 13 wherein the camera changes its field of view by using cropping or zooming to change the field of view.

16. An apparatus comprising:
a processor determining or obtaining a crime heat map wherein the crime heat map indicates geographic areas with a probability of crime occurrence;
the processor determining a camera viewshed and generating a Pan, Tilt, and/or Zoom (PTZ) schedule for the camera based on the crime heat map and the camera viewshed.

17. The apparatus of claim 16 wherein the camera viewshed is determined by:
determining a geographic location or set of possible geographic locations for the camera;
determining the camera viewshed for the camera at the geographic location or set of possible geographic locations.

18. The apparatus of claim 17 wherein generating the PTZ schedule for the camera comprises determining areas within the camera viewshed that have a higher probability of crime occurrence, and generating the PTZ schedule so that the camera or multiple cameras captures those areas with greater frequency than other areas within its viewshed.

19. The apparatus of claim 16 further comprising:
a network interface transmitting the schedule to the camera or a camera controller.

20. (canceled)
